(19) United States
(12) Patent Application Publication
(10) Pub. No.: US 2009/0280765 A1
(43) Pub. Date: Nov. 12, 2009

(54) Method And System For On-Demand Filtering In A Receiver

(76) Inventors: Ahmadreza Rofougaran, Newport Coast, CA (US); Maryam Rofougaran, Rancho Palos Verdes, CA (US)

Correspondence Address: MCANDREWS HELD & MALLOY, LTD, 500 WEST MADISON STREET, SUITE 3400, CHICAGO, IL, 60661, US

(21) Appl. No.: 12/116,874

(22) Filed: May 7, 2008

(51) Int. Cl. H04B 17/00

(52) U.S. Cl. 455/226.2

(57) ABSTRACT

Aspects of a method and system for on-demand filtering in a receiver. In this regard, one or more filters in a receiver may be configured based on measurement and/or characterization of a signal received by the receiver and based on power consumption of the filters. In this regard, the filters may be configured based on a strength of in-band and/or out-of-band signals, and signal to noise ratio of a signal, and/or a dynamic range of a signal. The filters may be configured by switching one or more stages and/or components into and/or out of a signal path. In this manner, a trade off may be made between filter response and power consumption by powering down portions of a filter not in use. Additionally, the filters may be configured by tuning one or more variable elements within the filters.

### CROSS-REFERENCE TO RELATED APPLICATIONS/INCORPORATION BY REFERENCE

This patent application makes reference to:

U.S. patent application Ser. No. 11/954,962, filed on Dec. 12, 2007;
U.S. patent application Ser. No. 11/955,064, filed on Dec. 12, 2007; and
U.S. patent application Ser. No. ______ (Attorney Docket No. 19250US01) filed on even date herewith.

Each of the above stated applications is hereby incorporated herein by reference in its entirety.

### FIELD OF THE INVENTION

Certain embodiments of the invention relate to signal processing. More specifically, certain embodiments of the invention relate to a method and system for on-demand filtering in a receiver.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

As the number of electronic devices enabled for wireline and/or mobile communications continues to increase, significant efforts exist with regard to making such devices more power efficient. For example, a large percentage of communications devices are mobile wireless devices and thus often operate on battery power. Additionally, transmit and/or receive circuitry within such mobile wireless devices often account for a significant portion of the power consumed within these devices. Moreover, in some conventional communication systems, transmitters and/or receivers are often power inefficient in comparison to other blocks of the portable communication devices. Accordingly, these transmitters and/or receivers have a significant impact on battery life for these mobile wireless devices.

Additionally, as the number of wireless devices and wireless communications standards increase, commonly used frequency bands are becoming increasingly congested with wireless traffic. In this regard, designing devices that can reliably operate in such noisy frequency bands is becoming increasingly difficult and costly. Accordingly, efforts exist to develop wireless technologies which operate at higher, less congested frequencies.

For example, in 2001, the Federal Communications Commission (FCC) designated a large contiguous block of 7 GHz bandwidth for communications in the 57 GHz to 64 GHz spectrum. This frequency band may be used by the spectrum users on an unlicensed basis, that is, the spectrum is accessible to anyone, subject to certain basic, technical restrictions such as maximum transmission power and certain coexistence mechanisms. The communications taking place in this band are often referred to as ‘60 GHz communications’. With respect to the accessibility of this part of the spectrum, 60 GHz communications is similar to other forms of unlicensed spectrum use, for example Wireless LANs or Bluetooth in the 2.4 GHz ISM bands. However, communications at 60 GHz may be significantly different in aspects other than accessibility. In this regard, there may be certain drawbacks associated with 60 GHz communications. For example, 60 GHz signals may provide markedly different communications channel and propagation characteristics. In this regard, 60 GHz radiation is partly absorbed by oxygen in the air. Accordingly, 60 GHz communications suffer from increased attenuation with distance as compared to, for example, 2.4 GHz. On the other hand, there may be advantages associated with 60 GHz communications. For example, since a very large bandwidth of 7 GHz is available, very high data rates may be achieved.

Shrinking features size of CMOS processes, for example, is one factor enabling development products and technologies for 60 GHz communications. However, even when fabricated on the smallest processes, conventional methods and circuit topologies are often unable to realize signal generation circuits which can generate signals sufficiently high in frequency to enable technologies such as 60 GHz communications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for on-demand filtering in a receiver, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary wireless device, in accordance with an embodiment of the invention.

FIG. 1B is a block diagram of an exemplary receiver with on-demand filtering, in accordance with an embodiment of the invention.

FIG. 1C is a block diagram of an exemplary configurable filter, in accordance with an embodiment of the invention.

FIG. 2 is a diagram illustrating an exemplary frequency spectrum of signals arriving at a receiver with on-demand filtering, in accordance with an embodiment of the invention.

FIG. 3 is a flow chart illustrating exemplary steps for on-demand filtering in a receiver, in accordance with an embodiment of the invention.

### DETAILED DESCRIPTION OF THE INVENTION

Certain embodiments of the invention may be found in a method and system for on-demand filtering in a receiver. In various embodiments of the invention, one or more filters in a receiver may be configured based on measurement and/or characterization of a signal received by the receiver and based on power consumption of the filters. In this regard, the filters may be configured based on a strength of in-band and/or out-of-band signals, a signal to noise ratio of a signal, and/or a dynamic range of a signal. The filters may be configured by switching one or more stages and/or components into and/or out of a signal path. In this manner, a trade off may be made between filter response and power consumption by powering down portions of a filter not in use. Additionally, the filters may be configured by tuning one or more variable elements within the filters.

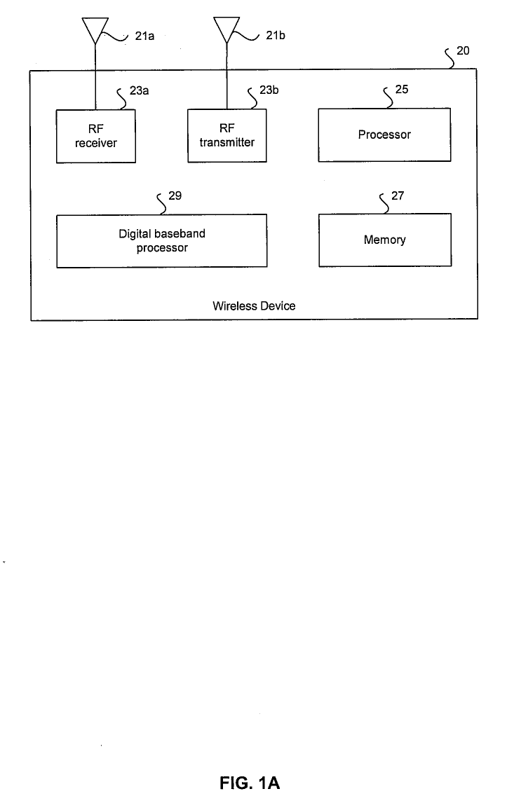

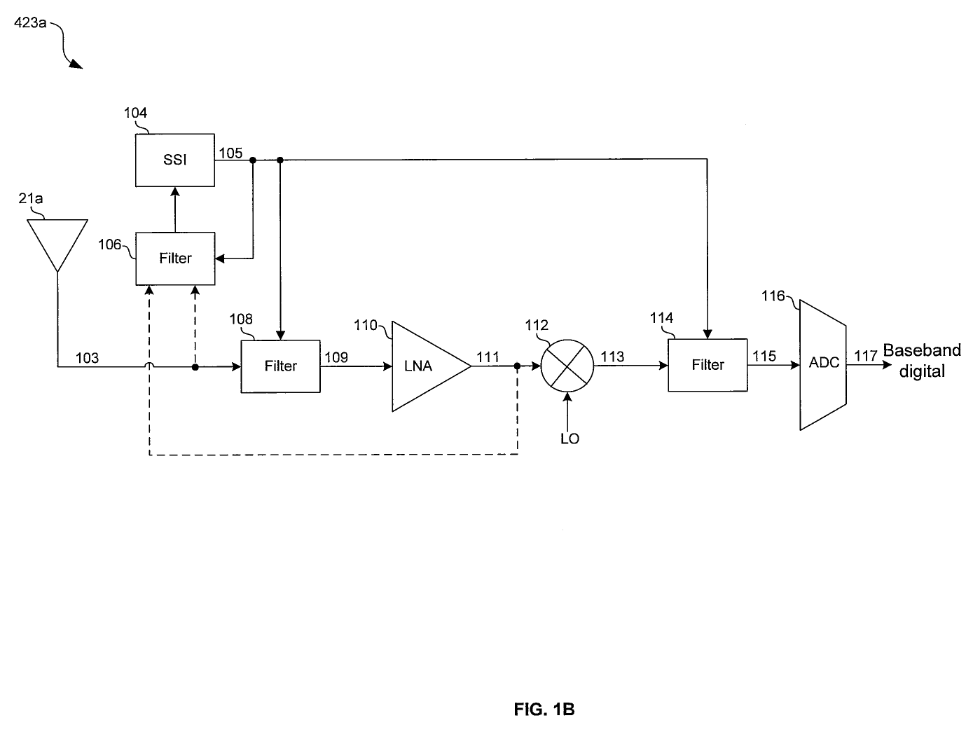

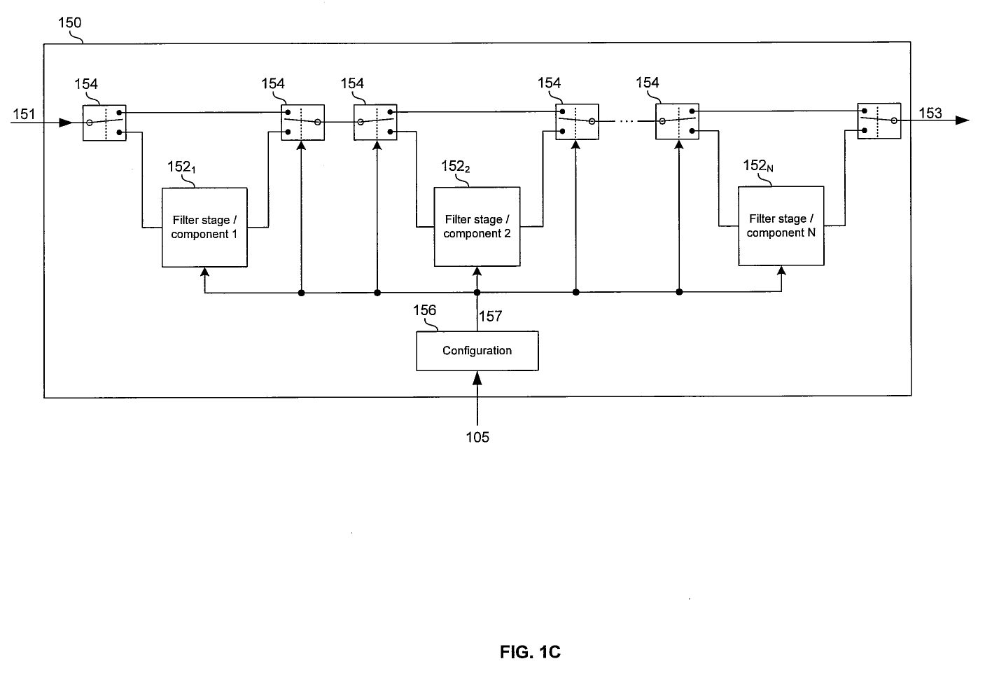

Referring to FIG. 1A, there is shown a wireless device 20 that may comprise an RF receiver 23a, an RF transmitter 23b, a digital baseband processor 429, a processor 25, and a memory 27. A receive antenna 21a may be communicatively coupled to the RF receiver 23a. A transmit antenna 21b may be communicatively coupled to the RF transmitter 23b. The wireless device 20 may transmit and receive information utilizing high data rate, line-of-site communications operating at extremely high frequency (EHF) such as the ISM band centered at 61.25 GHz.

The RF receiver 23a may comprise suitable logic, circuitry, and/or code that may enable processing of received RF signals. The RF receiver 23a may enable receiving RF signals in a plurality of frequency bands. For example, the RF receiver 23a may enable receiving signals in extremely high frequency (e.g., 60 GHz) bands. The receiver 23a may be as described with respect to FIG. 1B, for example. In this regard, the receiver 23a may be enabled to receive, filter, amplify, down-convert, and/or perform analog to digital conversion. Moreover, filtering in the receiver 23a may be dynamically controlled, and thus power efficiency of the receiver 23a may be improved over conventional receivers. In various embodiments of the invention, the wireless device 20 may comprise a plurality of the receivers 23a and may thus support multiple frequency bands and or simultaneous reception of signals in the same frequency band. In various embodiments of the invention, the RF receiver 23a may down convert a received RF signal to baseband or to an intermediate frequency (IF). Additionally, the receiver 23a may perform quadrature down-conversion where in-phase components and quadrature phase components may be processed in parallel.

The digital baseband processor 29 may comprise suitable logic, circuitry, and/or code that may enable processing and/or handling of baseband signals. In this regard, the digital baseband processor 29 may process or handle signals received from the RF receiver 23a and/or signals to be transferred to the RF transmitter 23b, when the RF transmitter 23b is present, for transmission to the network. The digital baseband processor 29 may also provide control and/or feedback information to the RF receiver 23a and to the RF transmitter 23b based on information from the processed signals. In this regard, the baseband processor 29 may provide a control signal to one or more of SSI 104, the LNA 110, the mixer 112, the filter 114 (and possibly 106 and 108), and/or the ADC 116. The digital baseband processor 29 may communicate information and/or data from the processed signals to the processor 25 and/or to the memory 27. Moreover, the digital baseband processor 29 may receive information from the processor 25 and/or to the memory 27, which may be processed and transferred to the RF transmitter 23b for transmission to the network.

The RF transmitter 23b may comprise suitable logic, circuitry, and/or code that may enable processing of RF signals for transmission. The RF transmitter 23b may enable transmission of RF signals in a plurality of frequency bands. For example, the RF transmitter 23b may enable transmitting signals in extremely high frequency (EHF) bands such as the ISM centered at 61.25 GHz. Each frequency band supported by the RF transmitter 23b may have a corresponding front-end circuit for handling amplification and up conversion operations, for example. In this regard, the RF transmitter 23b may be referred to as a multi-band transmitter when it supports more than one frequency band. In another embodiment of the invention, the wireless device 20 may comprise more than one RF transmitter 23b, wherein each of the RF transmitter 23b may be a single-band or a multi-band transmitter. In various embodiments of the invention, the RF transmitter 23b may perform direct up conversion of the baseband signal to an RF signal. In some instances, the RF transmitter 23b may enable digital-to-analog conversion of the baseband signal components received from the digital baseband processor 29 before up conversion. In other instances, the RF transmitter 23b may receive baseband signal components in analog form.

The processor 25 may comprise suitable logic, circuitry, and/or code that may enable control and/or data processing operations for the wireless device 20. The processor 25 may be utilized to control at least a portion of the RF receiver 23a, the RF transmitter 23b, the digital baseband processor 29, and/or the memory 27. In this regard, the processor 25 may generate at least one signal for controlling operations within the wireless device 20. In this regard, the processor 25 may provide a control signal to one or more of SSI 104, the LNA 110, the mixer 112, the filter 114 (and possibly 106 and 108), and/or the ADC 116. The processor 25 may also enable executing of applications that may be utilized by the wireless device 20. For example, the processor 25 may execute applications that may enable displaying and/or interacting with content received via EHF communications.

The memory 27 may comprise suitable logic, circuitry, and/or code that may enable storage of data and/or other information utilized by the wireless device 20. For example, the memory 27 may be utilized for storing processed data generated by the digital baseband processor 29 and/or the processor 25. The memory 27 may also be utilized to store information, such as configuration information, that may be utilized to control the operation of at least one block in the wireless device 20. For example, the memory 27 may comprise information necessary to configure the RF receiver 23a to enable receiving signals at various signal levels and in the presence of varying amounts of interference. In this regard, the memory may store control and/or configuration information for one or more of the SSI 104, the LNA 110, the mixer 112, the filter 114 (and possibly 106 and 108), and/or the ADC 116.

FIG. 1B is a block diagram of an exemplary receiver with on-demand filtering, in accordance with an embodiment of the invention. Referring to FIG. 1B the receiver 23a may be comprise a signal strength indicator (SSI) 104, filters 106, 108, and 114, low noise amplifier (LNA) 110, mixer 112, and analog-to-digital converter (ADC) 116. In various embodiments of the invention, the components of the receiver 23a may reside on a common substrate, such as a silicon die. In this regard, the receiver 23a may be referred to as a system on chip.

The SSI 104 may comprise suitable logic, circuitry, and/or code that may enable determining signal strength. In this regard, the SSI 104 may, for example, be enabled to measure current, voltage and/or power of the signal 103 and/or 111. Additionally, the SSI 104 may be enabled to generate one or more control signals 105, which, in various embodiments of the invention, may be coupled to one or more of the filters 106, 108, and 114. In various embodiments of the invention, the signal 105 may be a digital and/or analog signal representation of the current, voltage, and/or power of the signal 103 and/or 111.

The filter 106 may comprise suitable logic, circuitry, and/or code for attenuating undesired frequencies to a greater extent than desired frequencies. In this regard, the filter 106 may have, for example, a bandpass frequency response. The filter 108 may be tunable such that a bandwidth and/or center frequency characterizing the frequency response of the filter may be adjustable. In this manner, the filter 106 may be controlled such that the SSI 104 may perform measurements of desired frequencies, bandwidths, etc. Additionally, the filter 106 may be configured based on measurements performed by the SSI 104. In this regard, one or more components and/or stages of the filter 106 may be switched into and/or out of a signal path of the filter 108 to control, for example, a gain, a bandwidth, a center frequency, and/or a passband and/or stopband response of the filter 106. Exemplary passband and/or stopband responses comprise Butterworth, Chebyshev, Cauer, and Bessel responses.

The filter 108 may comprise suitable logic, circuitry, and/or code for attenuating undesired frequencies to a greater extent than desired frequencies. In this regard, the filter 106 may have, for example, a bandpass frequency response. The filter 108 may be configurable such that a bandwidth, a center frequency, and/or a passband and/or stopband characteristic of the filter 108 may be configured. In this manner, the filter 108 may enable tuning the receiver 23a to a desired frequency, for example 60 GHz, and attenuating interference and/or noise present in the channel. Moreover, configuring the filter 108 may involve a trade-off between, for example, the response of the filter 108 and power consumption of the filter 108.

In an exemplary embodiment of the invention, switching additional components and/or stages into a signal path of the filter 108 may increase the stopband attenuation of the filter 108, but the additional components and/or stages may consume additional power. Conversely, switching components and/or stages out of a signal path of the filter 108 may reduce the power consumption of the filter 108 but may also reduce the stopband attenuation of the filter 108. In an exemplary embodiment of the invention, switching additional components and/or stages into a signal path of the filter 108 may decrease the bandwidth (i.e., increase selectivity) of the filter 108, but the additional components and/or stages may consume additional power. Conversely, switching components and/or stages out of a signal path of the filter 108 may reduce the power consumption of the filter 108 but also increase the bandwidth (i.e., reduce selectivity) of the filter 108.

The filter 114 may comprise suitable logic, circuitry, and/or code for attenuating undesired frequencies to a greater extent than desired frequencies. In this regard, the filter 114 may have, for example, a bandpass frequency response. The filter 114 may be configurable such that a bandwidth, a center frequency, and/or a passband and/or stopband characteristic of the filter 114 may be configured. In this manner, the filter 114 may be enabled to reject undesired inter-modulation products output by the mixer 112 while passing desired inter-modulation products. Moreover, configuring the filter 108 may involve a trade-off between, for example, the response of the filter 108 and power consumption of the filter 108. In an exemplary embodiment of the invention, switching additional components and/or stages into a signal path of the filter 108 may increase the stopband attenuation of the filter 108, but the additional components and/or stages may consume additional power. Conversely, switching components and/or stages out of a signal path of the filter 108 may reduce the power consumption of the filter 108 but also reduce the stopband attenuation of the filter 108. In an exemplary embodiment of the invention, switching additional components and/or stages into a signal path of the filter 108 may decrease the bandwidth (i.e., increase selectivity) of the filter 108, but the additional components and/or stages may consume additional power. Conversely, switching components and/or stages out of a signal path of the filter 108 may reduce the power consumption of the filter 108 but also increase the bandwidth (i.e., reduce selectivity) of the filter 108.

The mixer 112 may comprise suitable logic, circuitry, and/or code that may enable generation of inter-modulation products resulting from the mixing of a received RF signal and a local oscillator (LO). The frequency of the LO signal may be determined based on the desired frequency/channel to be received. In this regard, the mixer 112 may enable down-converting, for example, RF signals of a range of frequencies to a fixed intermediate frequency (IF) or directly to baseband.

The LNA 110 may comprise suitable logic, circuitry, and/or code that may enable buffering and/or amplification of received RF signals. In this regard, the gain of the LNA 110 may be adjustable to enable reception of signals of varying strength. Accordingly, the output 111 of the LNA 110 may be measured (e.g., by the SSI 104) and the gain of the LNA 110 may be adjusted to maintain the signal 111 within determined limits.

The ADC 116 may comprise suitable logic, circuitry, and/or code that may enable conversion of analog signals to a digital representation. In this regard, the ADC 116 may, for example, sample and quantize analog signal 115 at times specified by a sample clock. Accordingly, the ADC 116 may receive one or more control signals from, for example, a processor and/or a clock generator.

In operation, an RF signal received by the antenna 21a and/or the LNA output 111 may be measured to determine signal strength of in-band and/or out-of-band signals. In this regard, in-band may refer to signals within a passband of the filter 108 while out-of-band signals may fall in a stopband of the filter 108. The filter 106 may be adjusted and/or tuned and measurements may be taken at various frequencies and/or bandwidths in order to determine the in-band and/or out-of-band signal strengths. Alternatively, the SSI 104 may be enabled to determine other characteristics (e.g., signal to noise ratio, dynamic range, etc.) of the received signal by, for example, performing a fast Fourier transform analysis of the signal 103 and/or 111.

Signal strength measurements may be utilized real-time to configure the filters 106, 108, and/or 114. In this manner, the receiver 423a may be configured to manage a frequency response of the filters 106, 108, and 114 and power consumption of the filters 106, 108, and 114, respectively.

FIG. 1C is a block diagram of an exemplary configurable filter, in accordance with an embodiment of the invention. Referring to FIG. 1B there is shown a filter 150 comprising a plurality of filter stages and/or components 152 and plurality of switching elements 154.

Each of the filter stages and/or components 152 may comprise suitable logic, circuitry, and/or code for affecting the response of the filter 150. Additionally, each of the stages and/or components 152 may be tunable or otherwise configurable via one or more signals 205. For example, each stage and/or component 152 may comprise one or more variable capacitors, inductors, and/or resistors, which may be controlled via one or more signals 157 generated by the configuration block 156. Furthermore, each stage and/or component 152 or a portion thereof may be powered down when not switched into a signal path of the receiver 23a.

The configuration block 156 may comprise suitable logic, circuitry, and/or code for configuring the filter 150 based on the signal(s) 205 generated by the SSI 104. In this regard, the configuration block 156 may generate one or more signals 157 for tuning the stages and/or components 152 and for switching the stages and/or components 152 in and/or out of the signal path via the switching elements 152 based on the signal(s) 105 generated by the SSI 104.

In operation, switching one or more of the stages and/or components 152 into and/or out of the signal path, via the switching elements 154, may vary the bandwidth, center frequency, gain, and/or response characteristic of the filter 150. Additionally, tuning the stages and/or components 152 that are switched into the signal path may enable further control of the response of the filter 150.

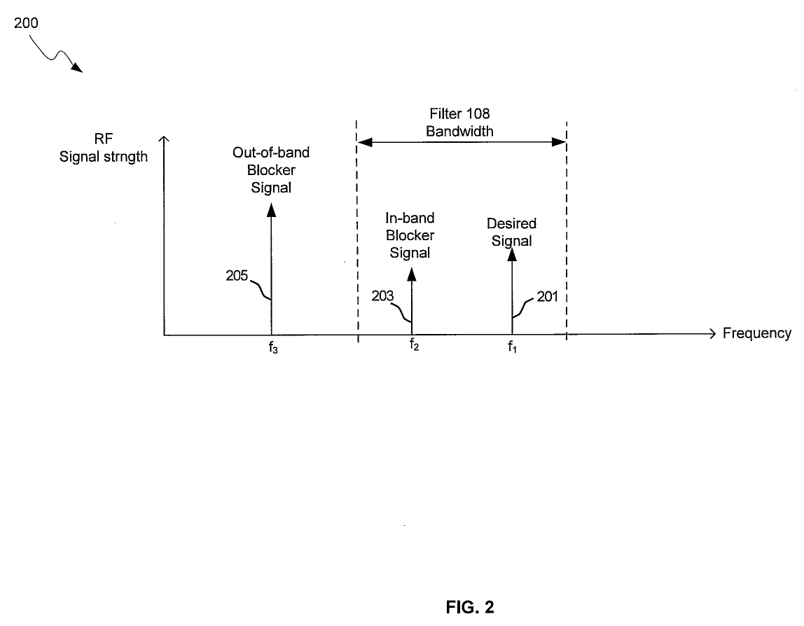

FIG. 2 is a diagram illustrating an exemplary frequency spectrum of signals arriving at a receiver with on-demand filtering, in accordance with an embodiment of the invention. Referring to FIG. 2, there is shown a signal 200 comprising a desired component 201, in-band blocker (interference) signal component 203, and out-of-band blocker (interference) signal component 205. Accordingly, the SSI 104 may be enabled to measure the strength of the signal components 201, 203, and/or 205 and adjust filtering in the receiver 23a accordingly. In an exemplary embodiment of the invention, the signal component 201 may be a desired channel, the signal component 205 may be an adjacent channel, and the signal component 203 may be interference from, for example, a different technology or wireless standard.

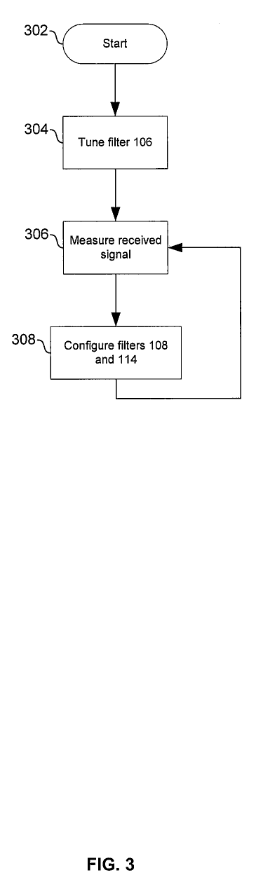

FIG. 3 is a flow chart illustrating exemplary steps for on-demand filtering in a receiver, in accordance with an embodiment of the invention. Referring to FIG. 3 the exemplary steps may begin with start step 302 when signals may be received by the antenna 21a. Subsequent to step 302, the exemplary steps may advance to step 304. In step 304, the filter 106 may be tuned to control which frequencies may be measured by the SSI 104. For example, the filter 106 may sweep one or more frequency bands to characterize the environment in which the receiver 23a may be operating. Subsequent to step 304, the exemplary steps may advance to step 306.

In step 306, the SSI 104 may provide a measure of the signal strength of the signal 103 and/or 111. Accordingly, the signal 105 generated by the SSI 104 may be based, at least in part, on the results of the measurement of the signal 103 and/or 111. In this manner, the filters 108 and/or 114 may be configured real-time in response to measurements of received signals. For example, the signal 105 may be a DC voltage which may be utilized to configure the filters 108 and 114 and balance, respectively, the response of the filters 108 and 114 with the power consumption of the filters 108 and 114. In another embodiment of the invention, the signal 105 may be a periodic signal and exemplary characteristics comprising phase, frequency, and/or duty cycle, of the signal 105 may, at least in part, be utilized to configure the filters 108 and 114 and balance, respectively, the response of the filters 108 and 114 with the power consumption of the filters 108 and 114. Subsequent to step 306, the exemplary steps may advance to the step 308.

In step 308, the filters 108 and 114 may be configured based on the signal(s) 105. In this regard, the filter 108 may be tuned to a desired channel for reception and processing by receiver 423a. In this manner, a passband of the filter 108 may be referred to herein as “in-band”. Similarly, the filter 114 may be tuned to select a desired inter-modulation product from the mixer 112 and reject undesired inter-modulation products generated by the mixer 112.

Subsequent to step 308, the exemplary steps may return to step 306. In this regard, the process of monitoring signal levels and configuring the filters 108 and 114 to manage filter performance and filter power consumption may be based on periodic or continuous feedback to improve efficiency of the receiver 23a.

Aspects of a method and system for on-demand filtering in a receiver. In this regard, one or more filters 108 and/or 114 in the receiver 23a may be configured based on measurement and/or characterization of a signal, such as the signal 200, received by the receiver and based on power consumption of the filters. In this regard, the filters may be configured based on strength of in-band signal components 201 and 203 and/or out-of-band signal components 205 and signal to noise ratio of a signal, and/or a dynamic range of a signal. The filters 108 and/or 114 may be configured by switching one or more stages and/or components 152 into and/or out of a signal path. In this manner, a trade-off may be made between filter response and power consumption by powering down portions of a filter not in use. Additionally, the filters may be configured by tuning one or more variable elements within the filters.

Another embodiment of the invention may provide a machine-readable storage, having stored thereon, a computer program having at least one code section executable by a machine, thereby causing the machine to perform the steps as described herein for on-demand filtering in a receiver.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
measuring a signal strength of a signal, said signal received by a receiver via one or more antennas; and
responsive to said measuring, configuring one or more filters within said receiver based on said measured signal strength and based on power consumption of said one or more filters.

2. The method according to claim 1, comprising configuring said one or more filters based on measured signal strength of at least one in-band signal component.

3. The method according to claim 1, comprising configuring said one or more filters based on measured signal strength of at least one out-of-band signal component.

4. The method according to claim 1, comprising configuring said one or more filters based on a signal to noise ratio of said signal received by said one or more antennas.

5. The method according to claim 1, comprising configuring said one or more filters based on a dynamic range of said signal received by said one or more antennas.

6. The method according to claim 1, comprising configuring said one or more filters by switching one or more stages of said filter into and/or out of a signal path.

7. The method according to claim 6, comprising managing said power consumption of said filters by removing power to stages switched out of said signal path.

8. The method according to claim 1, comprising configuring said one or more filters by tuning one or more variable circuit elements within said filter.

9. The method according to claim 1, wherein said signal received by said one or more antennas are of frequency at or near the industrial scientific and medical band centered at 61.25 GHz.

10. The method according to claim 1, wherein said measurement and/or said configuration is performed real-time.

11. A machine-readable storage having stored thereon, a computer program having at least one code section for signal processing, the at least one code section being executable by a machine for causing the machine to perform steps comprising:
measuring a signal strength of a signal received by a receiver, said signal received via one or more antennas; and
responsive to said measuring, configuring one or more filters within said receiver based on said measured signal strength and based on power consumption of said one or more filters.

12. The machine-readable storage according to claim 11, wherein said at least one code section comprises code for configuring said one or more filters based on measured signal strength of at least one in-band signal component.

13. The machine-readable storage according to claim 11, wherein said at least one code section comprises code for configuring said one or more filters based on measured signal strength of at least one out-of-band signal component.

14. The machine-readable storage according to claim 11, wherein said at least one code section comprises code for configuring said one or more filters based on a signal to noise ratio of said signal received by said one or more antennas.

15. The machine-readable storage according to claim 11, wherein said at least one code section comprises code for configuring said one or more filters based on a dynamic range of said signal received by said one or more antennas.

16. The machine-readable storage according to claim 11, wherein said at least one code section comprises code for configuring said one or more filters by switching one or more stages of said filter into and/or out of a signal path.

17. The machine-readable storage according to claim 16, wherein said at least one code section comprises code for managing said power consumption of said filters by removing power to stages switched out of said signal path.

18. The machine-readable storage according to claim 11, wherein said at least one code section comprises code for configuring said one or more filters by tuning one or more variable circuit elements within said filter.

19. The machine-readable storage according to claim 11, wherein said signal received by said one or more antennas are of frequency at or near the industrial scientific and medical band centered at 61.25 GHz.

20. The machine-readable storage according to claim 11, wherein said measurement and/or said configuration is performed real-time.

21. A system for signal processing, the system comprising:
one or more circuits comprising one or more filters, wherein said one or more circuits are operable to measure a signal strength of a signal received by a receiver via said one or more antennas; and
responsive to said measurement, said one or more circuits are operable to configure one or more filters within said receiver based on said measured signal strength and based on power consumption of said one or more filters.

22. The system according to claim 21, wherein said one or more circuits are operable to configure said one or more filters based on measured signal strength of at least one in-band signal component.

23. The system according to claim 21, wherein said one or more circuits are operable to configure said one or more filters based on measured signal strength of at least one out-of-band signal component.

24. The system according to claim 21, wherein said one or more circuits are operable to configure said one or more filters based on a signal to noise ratio of said signal received by said one or more antennas.

25. The system according to claim 21, wherein said one or more circuits are operable to configure said one or more filters based on a dynamic range of said signal received by said one or more antennas.

26. The system according to claim 21, wherein said one or more circuits are operable to configure said one or more filters by switching one or more stages of said filter into and/or out of a signal path.

27. The system according to claim 26, wherein said one or more circuits are operable to manage said power consumption of said filters by removing power to stages switched out of said signal path.

28. The system according to claim 21, wherein said one or more circuits comprises one or more variable circuit elements within said filter, and said one or more circuits are operable to configure said one or more filters by tuning said one or more variable circuit elements within said filter.

29. The system according to claim 21, wherein said signal received by said one or more antennas is of frequency at or near the industrial scientific and medical band centered at 61.25 GHz.

30. The system according to claim 21, wherein said measurement and/or said configuration is performed real-time.
